(19) United States
(12) Patent Application Publication
(10) Pub. No.: US 2025/0149948 A1
(43) Pub. Date: May 8, 2025

(54) HOUSING SEALING STRUCTURE AND ELECTRIC DRIVE DEVICE

(71) Applicant: ZF Friedrichshafen AG, Friedrichshafen (DE)

(72) Inventors: Wentao Zhang, Shanghai (CN); Ningzhong Fei, Shanghai (CN); Zhenhua Fan, Shanghai (CN); Xiaoyue Li, Shanghai (CN)

(73) Assignee: ZF Friedrichshafen AG, Friedrichshafen (DE)

(21) Appl. No.: 18/940,102

(22) Filed: Nov. 7, 2024

(30) Foreign Application Priority Data
Nov. 8, 2023 (CN) 202311478742.0

(51) Int. Cl. H02K 5/10; H02K 5/22

(52) U.S. Cl. CPC H02K 5/10; H02K 5/225; H02K 2203/09

(57) ABSTRACT

A housing sealing structure includes a housing body, a busbar assembly, and a sealing ring, wherein the housing body has a partition plate, and a first chamber and a second chamber on two sides of the partition plate. The partition plate is provided with a through hole through which the busbar assembly passes such that the busbar assembly is sealed at the through hole by the sealing ring. The housing body also includes a first snap-fit portion, and the busbar assembly includes a second snap-fit portion, the first snap-fit portion being snap-fitted with the second snap-fit portion, which ensures the busbar assembly is at a fixed position relative to the housing body to avoid seal failure caused by large compression difference between two sides of the sealing ring due to swing of the busbar assembly relative to the housing body during use, thereby further improving the sealing effect.

### CROSS-REFERENCE TO RELATED APPLICATION

This application claims priority to Chinese Patent Application No. 202311478742.0, filed on Nov. 8, 2023, the entirety of which is hereby fully incorporated by reference herein.

### TECHNICAL FIELD

The disclosure relates to the technical field of electric drive devices, and in particular to a housing sealing structure and an electric drive device.

### BACKGROUND

Electric drive devices are devices that use electric energy to drive a motor to rotate and then output power. Some of the electric drive devices employ a T-shape layout which specifically features in that a reduction gearbox is arranged between the motor and a motor controller. The motor controller converts direct current provided by a traction battery into alternating current and supplies the alternating current to a stator winding of the motor, so that three-phase electrical connection is provided between the motor controller and the stator winding of the motor, and in order to achieve the electrical connection, a busbar needs to be configured to be of a structure that passes from the motor controller into the reduction gearbox. Since the interior of the reduction gearbox is an oil chamber and the interior of the motor controller is a dry chamber, a sealing structure needs to be provided at a through hole through which the busbar passes from the motor controller into the reduction gearbox.

At present, since the busbar is relatively long and is affected by assembly errors, a V-shaped sealing ring has been used in most cases to seal the through hole, in order to counteract the impact of larger errors. However, the inventors have found that such a sealing structure is prone to leakage.

### SUMMARY

A brief summary of one or more aspects will be presented below to provide basic understanding of the aspects. This summary is not exhaustive in all contemplated aspects, and is neither intended to point out key or decisive elements in all aspects, nor attempted to define the scope of any or all aspects. The sole purpose thereof is to provide some concepts in one or more aspects in a simplified form as the preface to the more detailed description provided later.

The disclosure aims to provide a housing sealing structure, which can solve the technical problem of being prone to leakage in the prior art.

The disclosure also aims to further provide an electric drive device, which can solve the technical problem of being prone to leakage in the prior art.

An embodiment of the disclosure may be implemented by:
a housing sealing structure for use in an electric drive device comprising a motor, a transmission and a motor controller arranged in sequence, the housing sealing structure comprising:
a housing body having a partition plate, and a first chamber and a second chamber on two sides of the partition plate, the first chamber being configured to accommodate a transmission body to constitute the transmission, and the second chamber being configured to accommodate a motor controller body to constitute the motor controller;
a busbar assembly, the partition plate being provided with a through hole through which the busbar assembly passes such that the busbar assembly enters the first chamber from the second chamber; and
a sealing ring sleeved on the busbar assembly, an outer peripheral surface of the sealing ring fitting with a peripheral wall of the through hole in a sealing manner;
wherein the housing body is provided with a first snap-fit portion, and the busbar assembly is provided with a second snap-fit portion, the first snap-fit portion being snap-fitted with the second snap-fit portion to limit the position of the busbar assembly relative to the housing body.

Optionally, the partition plate is provided with a snap-fit groove serving as the first snap-fit portion, and the busbar assembly is provided with a boss serving as the second snap-fit portion.

Optionally, the snap-fit groove is an annular groove arranged surrounding the through hole, and the center line of the snap-fit groove is collinear with the center line of the through hole.

Optionally, the snap-fit groove is located on a side of the partition plate close to the second chamber.

Optionally, the through hole is formed in the bottom of the snap-fit groove, and a first guide surface is provided at an end of the through hole close to the snap-fit groove, and has a gradually shrinking opening in cross-section of the first guide surface in a direction from the snap-fit groove to the through hole to guide the sealing ring into the through hole.

Optionally, a second guide surface is provided at an opening of the snap-fit groove, and has a gradually shrinking opening in cross-section of the second guide surface in a direction of snap-in of the snap-fit groove with the boss to guide the boss to snap in the snap-fit groove.

Optionally, the sealing ring is a rectangular sealing ring.

Optionally, a plurality of first protrusions are provided on the outer peripheral surface of the rectangular sealing ring.

Optionally, the rectangular sealing ring further has an inner peripheral surface that fits with the busbar assembly in a sealing manner, and a plurality of second protrusions are provided on the inner peripheral surface.

Optionally, the housing body comprises a first housing portion, a second housing portion and a third housing portion connected in sequence, and the partition plate is formed at the second housing portion; the first housing portion and the second housing portion are connected to each other to jointly define the first chamber; and the second housing portion and the third housing portion are connected to each other to jointly define the second chamber.

Optionally, the busbar assembly comprises a busbar body and a support member that is made of plastic, the support member is connected to the busbar body, the sealing ring is sleeved on the support member, and the second snap-fit portion is arranged on the support member.

An electric drive device comprises a motor body, a transmission body, a motor controller body, and the housing sealing structure described above, wherein the motor body is mounted in the first chamber, the transmission body is mounted in the first chamber, and the motor controller body is mounted in the second chamber; and one end of the busbar assembly is connected to the motor controller body, and the other end of the busbar assembly is connected to the motor body.

The housing sealing structure and the electric drive device according to the embodiments of the disclosure have the following beneficial effects.

An embodiment of the disclosure provides a housing sealing structure comprising a housing body, a busbar assembly and a sealing ring. The housing body has a partition plate, and a first chamber and a second chamber on two sides of the partition plate, the first chamber being configured to accommodate a transmission body to constitute a transmission, and the second chamber being configured to accommodate a motor controller body to constitute a motor controller. The partition plate is provided with a through hole through which the busbar assembly passes such that the busbar assembly can enter the first chamber from the second chamber. The sealing ring is sleeved on the busbar assembly, and an outer peripheral surface of the sealing ring fits with the peripheral wall of the through hole in a sealing manner, such that the busbar assembly is sealed at the through hole by the sealing ring. The housing body is further provided with a first snap-fit portion, and the busbar assembly is provided with a second snap-fit portion, the first snap-fit portion being snap-fitted with the second snap-fit portion, which achieves accurate positioning of the busbar assembly to the housing body, thereby avoiding the impact caused by assembly errors. In addition, the snap-fitting between the first snap-fit portion and the second snap-fit portion ensures the busbar assembly to be at a fixed position relative to the housing body, which avoids seal failure caused by large compression difference between two sides of the sealing ring due to swing of the busbar assembly relative to the housing body during use, thereby further improving the sealing effect.

An embodiment of the disclosure further provides an electric drive device comprising the housing sealing structure described above. The electric drive device comprises the housing sealing structure described above, and thus has the beneficial effect of good sealing effect due to the busbar assembly being at a fixed position relative to the housing body.

### BRIEF DESCRIPTION OF THE DRAWINGS

The above features and advantages of the disclosure will be better understood from the detailed description of embodiments of the present disclosure with reference to the following drawings. In the drawings, the components are not necessarily drawn to scale, and the components having similar related characteristics or features may have the same or similar reference numerals.

FIG. 1 shows a block diagram of a structure of an electric drive device according to an aspect of the disclosure;

FIG. 2 shows a schematic diagram of a partial structure of the electric drive device according to an aspect of the disclosure;

FIG. 3 shows an enlarged schematic diagram of a partial structure of an electric drive device according to an aspect of the disclosure; and

FIG. 4 shows a schematic right view of a partial structure of a partition plate in a housing sealing structure according to an aspect of the disclosure.

### DETAILED DESCRIPTION

The disclosure will be described in detail below with reference to the drawings and specific embodiments. It should be noted that the aspects described below with reference to the drawings and the specific embodiments are merely exemplary and should not be construed as limiting the scope of protection of the disclosure.

In the description of the disclosure, it should be noted that the orientation or positional relationships indicated by the terms such as “upper”, “lower”, “inner”, “outer” and “vertical” are based on the orientation or positional relationships shown in the drawings or the orientation or position relationships in which a product of the disclosure is usually placed during use, rather than indicating or implying that the device or element indicated must have a specific orientation or be constructed and operated in the specific orientation, and therefore cannot construed as limiting the disclosure.

In addition, it should be noted that the terms such as “first” and “second” are merely intended to distinguish the description, and should not be construed as indicating or implying the relative importance.

In the description of the disclosure, it should also be noted that, unless otherwise explicitly specified or defined, the terms “mounting”, “connecting” and “connection” should be understood in a broad sense, for example, they may be a fixed connection, an integrated connection, or a detachable connection; may be a mechanical connection or an electrical connection; may be a direct connection or an indirect connection by an intermediate medium, or may be communication between interiors of two elements, etc. For those of ordinary skill in the art, the specific meaning of the above terms in the disclosure should be understood according to specific circumstances.

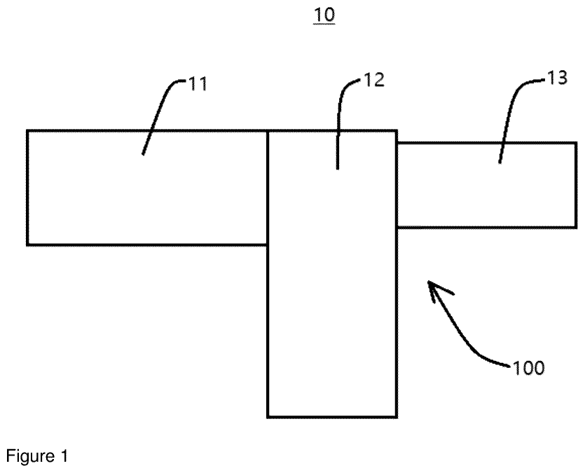

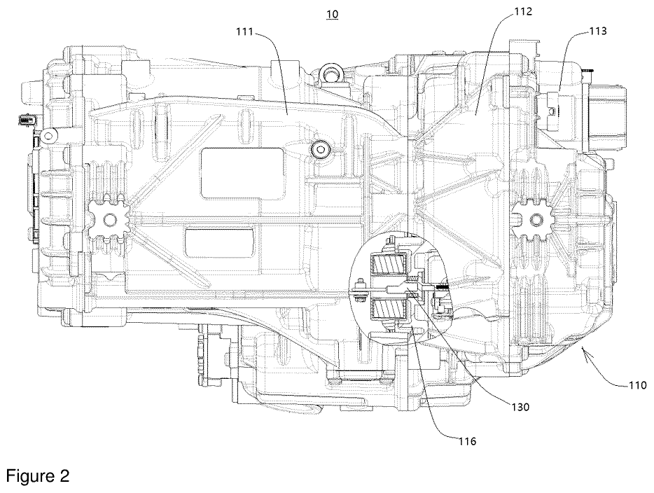

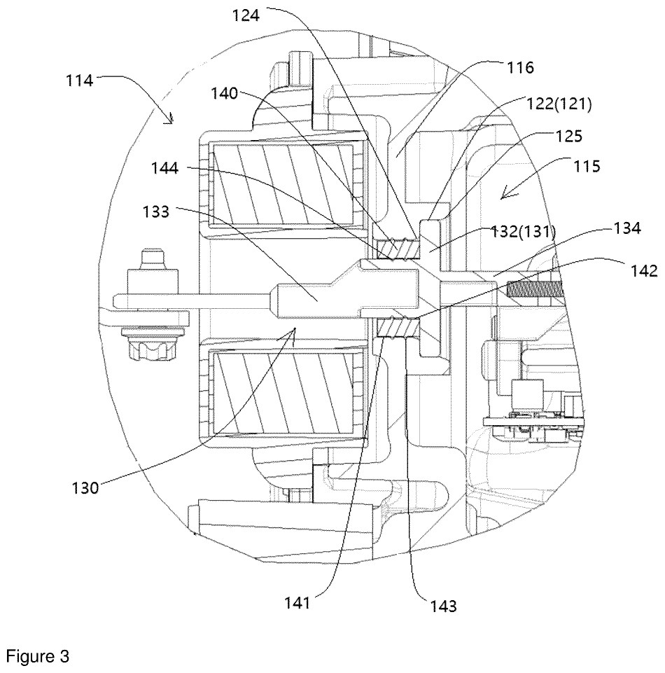

FIG. 1 is a block diagram of a structure of an electric drive device 10 according to this embodiment, FIG. 2 is a schematic diagram of a partial structure of the electric drive device 10 according to this embodiment, and FIG. 3 is an enlarged schematic diagram of a partial structure of the electric drive device 10 according to this embodiment. Referring to FIGS. 1 to 3, this embodiment provides a housing sealing structure 100, and accordingly provides an electric drive device 10.

The electric drive device 10 comprises the housing sealing structure 100, a motor body (not shown), a transmission body (not shown), and a motor controller body (not shown).

The housing sealing structure 100 comprises a housing body 110, a busbar assembly 130 and a sealing ring 140. The housing body 110 has a partition plate 116, and a first chamber 114 and a second chamber 115 on two sides of the partition plate, the first chamber 114 being configured to accommodate the transmission body, and the second chamber 115 being configured to accommodate the motor controller body. The partition plate 116 is provided with a through hole 123, and the busbar assembly 130 passes through the through hole 123 such that the busbar assembly 130 can enter the first chamber 114 from the second chamber 115. The sealing ring 140 is sleeved on the busbar assembly 130, and an outer peripheral surface 141 of the sealing ring 140 fits with a peripheral wall of the through hole 123 in a sealing manner, such that the busbar assembly 130 is sealed at the through hole 123 by the sealing ring 140. The housing body 110 is further provided with a first snap-fit portion 121, and the busbar assembly 130 is provided with a second snap-fit portion 131, the first snap-fit portion 121 being snap-fitted with the second snap-fit portion 131 so as to limit the position of the busbar assembly 130 relative to the housing body 110. On the one hand, the snap-fitting between the first snap-fit portion 121 and the second snap-fit portion 131 achieves accurate positioning of the busbar assembly 130 to the housing body 110, thereby avoiding the impact caused by assembly errors; and on the other hand, the snap-fitting between the first snap-fit portion 121 and the second snap-fit portion 131 ensures the busbar assembly 130 to be at a fixed position relative to the housing body 110 so as to avoid seal failure caused by large compression difference between two sides of the sealing ring 140 due to swing of the busbar assembly 130 relative to the housing body 110 during use, thereby further ensuring the sealing effect.

In addition, the motor body and the transmission body of the electric drive device 10 are both mounted in the first chamber 114, and the motor controller body of the electric drive device 10 is mounted in the second chamber 115. Specifically, the motor body is mounted in the first chamber 114, and the motor body and part of the housing body 110 constitute a motor 11. The transmission body is mounted in the first chamber 114, and the transmission body and part of the housing body 110 constitute a transmission 12. The motor controller body is mounted in the second chamber 115 and thus forms a motor controller 13 together with part of the housing body 110. In other words, the electric drive device 10 may also be regarded as comprising the motor 11, the transmission 12 and the motor controller 13 arranged in sequence. One end of the busbar assembly 130 is connected to the motor controller body, and the other end of the busbar assembly 130 is connected to the motor body, so that alternating current converted by the motor controller body is transmitted to the motor body by the busbar assembly 130.

Optionally, the housing body 110 may be configured to comprise a first housing portion 111, a first second portion 112 and a third housing portion 113. The first housing portion 111, the second housing portion 112 and the third housing portion 113 are connected in sequence to form the housing body 110. The partition plate 116 is formed at the second housing portion 112, the first housing portion 111 and the second housing portion 112 are connected to each other to jointly define the first chamber 114, and the second housing portion 112 and the third housing portion 113 are connected to each other to jointly define the second chamber 115.

It should be noted that the configuration of the housing body 110 is not defined herein, and it should be understood that in some other embodiments the housing body 110 may also be configured as, for example, a vertically split structure, in which a part of the first chamber 114 and a part of the second chamber 115 are defined by an upper portion of the housing body 110, and the other part of the first chamber 114 and the other part of the second chamber 115 are defined by a lower half portion of the housing body 110.

Continuing to refer to FIGS. 1 to 3, in this embodiment, the partition plate 116 is provided with a snap-fit groove 122 serving as the first snap-fit portion 121, and in other words, the first snap-fit portion 121 is the snap-fit groove 122 formed in the partition plate 116. The busbar assembly 130 is provided with a boss 132 serving as the second snap-fit portion 131, in other words, the second snap-fit portion 131 is the boss 132 provided on the busbar assembly 130, and the snap-fitting between the boss 132 and the snap-fit groove 122 achieves positioning of the busbar assembly 130 to the partition plate 116.

It should be noted that the specific structure of the first snap-fit portion 121 and the second snap-fit portion 131 is not limited herein, and it should be understood that in some other embodiments other structures may also be used as the first snap-fit portion 121 and the second snap-fit portion 131. For example, the first snap-fit portion 121 is configured as a protruding structure on the partition plate 116, and the second snap-fit portion 131 is configured as a groove structure in the busbar assembly 130, etc.

Specifically, the busbar assembly 130 comprises a busbar body 133 and a support member 134. One end of the busbar body 133 is connected to the motor body, and the other end thereof is connected to the motor controller body, such that the motor body is in conduction with the motor controller body by the busbar body 133. The support member 134 may be made of plastic and is connected to the busbar body 133, and the sealing ring 140 is sleeved outside the support member 134. In addition, in this embodiment, the second snap-fit portion 131 is also arranged on the support member 134.

Continuing to refer to FIGS. 1 to 3, the sealing ring 140 is a rectangular sealing ring in this embodiment. Specifically, the rectangular sealing ring has an outer peripheral surface 141 that fits with the through hole 123 in a sealing manner and an inner peripheral surface 142 that fits with the busbar assembly 130 in a sealing manner. It should be understood that other types of sealing ring, such as an O-shaped sealing ring, may also be used as desired in other embodiments.

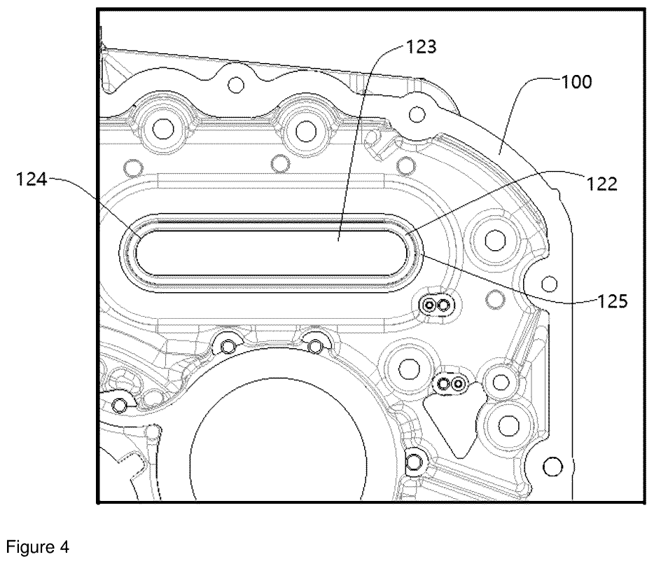

FIG. 4 is a schematic right view of a partial structure of the partition plate 116 in the housing sealing structure 100 according to this embodiment. Referring to FIGS. 1 to 4, further, the snap-fit groove 122 is an annular groove arranged surrounding the through hole 123, and the center line of the snap-fit groove 122 is collinear with the center line of the through hole 123. In this way, the through hole 123 and the snap-fit groove 122 are machined by clamping in one go, which avoids the accumulation of errors caused by clamping for many times. By ensuring the accuracy of snap-fitting between the boss 132 and the snap-fit groove 122, it is possible to effectively ensure the assembly accuracy of the support member 134 to the through hole 123. In addition, since the snap-fit groove 122 is an annular groove arranged surrounding the through hole 123, the boss 132 is correspondingly an annular protrusion arranged surrounding the busbar assembly 130, so that the swing of the busbar assembly 130 relative to the housing body 110 in all directions can be limited by the snap-fitting between the snap-fit groove 122 and the boss 132.

Optionally, in this embodiment, the through hole 123 is an oblong hole, and is arc-shaped at both ends in a length direction of the oblong hole. Correspondingly, the snap-fit groove 122 is of an oblong shape that is consistent with the shape of the through hole 123 and has a larger contour size than the through hole 123.

Further, the snap-fit groove 122 is located on a side of the partition plate 116 close to the second chamber 115. In this way, during mounting, the busbar assembly 130 and the motor controller body may be connected together, and then when the motor controller body is mounted to the second housing portion 112, the busbar assembly 130 is inserted into the through hole 123 from right to left as shown in FIG. 1, and as the busbar assembly 130 is inserted into the through hole 123, the boss 132 is inserted into the snap-fit groove 122.

Further, the through hole 123 is formed in the bottom of the snap-fit groove 122, and in other words, the space enclosed by the through hole 123 is in communication with the space enclosed by the snap-fit groove 122. A first guide surface 124 is provided at an end of the through hole 123 close to the snap-fit groove 122 and has a gradually shrinking opening in cross-section of the first guide surface 124 in a direction from the snap-fit groove 122 to the through hole 123 to guide the sealing ring 140 into the through hole 123.

Specifically, the connection between the through hole 123 and the bottom of the snap-fit groove 122 is configured as a chamfer which forms the first guide surface 124 that guides the sealing ring 140 into the through hole 123. In addition, in order to ensure the sealing effect, the sealing ring 140 needs to have a certain radial compression after being mounted into the through hole 123, and in this embodiment the sealing ring 140 is a rectangular sealing ring, that is, the sealing ring 140 has a rectangular cross-section, and the outer peripheral surface 141 thereof is an annular cylindrical surface with the same thickness throughout the surface. Thus, providing the first guide surface 124 can not only guide the busbar assembly 130 into the through hole 123 to reduce the alignment difficulty, but also progressively increase the radial compression of the sealing ring 140 as the sealing ring 140 is mounted, which facilitates the mounting of the sealing ring 140.

In this embodiment, a second guide surface 125 is provided at the opening of the snap-fit groove 122 and has a gradually shrinking opening in cross-section of the second guide surface 125 in a direction of snap-in of the snap-fit groove 122 with the boss 132 to guide the boss 132 into the snap-fit groove 122.

Specifically, a chamfer is provided at the opening of the snap-fit groove 122, that is, at the end of the snap-fit groove 122 away from the through hole 123, the chamfer guides the boss 132 into the snap-fit groove 122 to form the second guide surface 125, and the second guide surface 125 has a gradually shrinking opening in a direction from right to left as shown in FIGS. 1 and 2, which can ensure the boss 132 to be smoothly mounted into the snap-fit groove 122 when the boss 132 and the snap-fit groove 122 have a small fit tolerance.

Optionally, in order to ensure that the boss 132 and the snap-fit groove 122 have a sufficiently small assembly tolerance, the snap-fit groove 122 may be machined first during machining, and then the boss 132 may be machined according to the size of the machined snap-fit groove 122, thereby ensuring that the accuracy of fitting between the boss 132 and the snap-fit groove meets the requirements.

Further, the depth of the snap-fit groove 122 is greater than the thickness of the boss 132. Specifically, since the second guide surface 125 is provided at the opening of the snap-fit groove 122, the peripheral surface of the snap-fit groove 122 is composed of the cylindrical surface and the second guide surface 125, the depth of the snap-fit groove 122 is enough to allow the boss 132 to snap in the snap-fit groove 122, the second guide surface 125 is located on one side of the boss 132, and the peripheral surface of the boss 132 only fits with the cylindrical surface of the snap-fit groove 122, in other words, the corresponding depth of the cylindrical surface of the snap-fit groove 122 is greater than or equal to the thickness of the boss 132.

Further, a plurality of first protrusions 143 is provided on the outer peripheral surface 141, and after the sealing ring 140 is mounted into the through hole 123, the first protrusions 143 are deformed due to the compression by the through hole 123, which can increase the deformation by compression between the sealing ring 140 and the through hole 123 and thus ensure the sealing performance between the sealing ring 140 and the through hole 123, and compared with increasing the thickness of the sealing ring 140 (i.e., the distance between the outer peripheral surface 141 and the inner peripheral surface 142 of the sealing ring 140), providing the plurality of first protrusions 143 is conductive to reducing the mounting difficulty.

Optionally, the first protrusion 143 may be an annular protrusion extending in the circumferential direction of the sealing ring 140, and the plurality of first protrusions 143 are distributed at intervals in the axial direction of the sealing ring 140; or the first protrusion 143 may be a spot-like protrusion arranged on the outer peripheral surface 141 of the sealing ring 140, and the plurality of first protrusions 143 are randomly distributed on the outer peripheral surface 141 of the sealing ring 140.

Further, a plurality of second protrusions 144 is provided on the inner peripheral surface 142, and after the sealing ring 140 is sleeved on the busbar assembly 130 and the sealing ring 140 is mounted into the through hole 123, the second protrusions 144 are elastically deformed by a compression force, which can increase the deformation by compression between the sealing ring 140 and the busbar assembly 130 and thus ensure the sealing performance between the sealing ring 140 and the busbar assembly 130, and compared with increasing the thickness of the sealing ring 140, providing the plurality of second protrusions 144 is conductive to reducing the mounting difficulty.

Optionally, the second protrusion 144 may be an annular protrusion extending in the circumferential direction of the sealing ring 140, and the plurality of second protrusions 144 are distributed at intervals in the axial direction of the sealing ring 140; or the second protrusion 144 may be a spot-like protrusion arranged on the inner peripheral surface 142 of the sealing ring 140, and the plurality of second protrusions 144 are randomly distributed on the inner peripheral surface 142 of the sealing ring 140.

According to the housing sealing structure 100 and the electric drive device 10 according to the embodiments of the disclosure, the snap-fitting between the first snap-fit portion 121 and the second snap-fit portion 131 limits the position of the busbar assembly 130 relative to the housing body 110, which can also ensure the assembly accuracy even when there is a large error of fitting between the busbar assembly 130 and the through hole 123, thereby ensuring the sealing effect; and it is also ensured that the busbar assembly 130 is at a fixed position relative to the housing body 110 during use, which avoids seal failure caused by inconsistent deformation by compression on two sides of the sealing ring 140 due to swing of the busbar assembly 130 relative to the housing body 110, thereby improving the sealing effect. In addition, the sealing ring 140 arranged in the housing sealing structure 100 is a rectangular sealing ring, and the sealing between the through hole 123 and the busbar assembly 130 by the rectangular sealing ring effectively ensures that the pressure change in the first chamber 114 and the second chamber 115 can ensure the sealing effect, that is, can achieve good sealing when the pressure in the first chamber 114 is greater than the pressure in the second chamber 115, when the pressure of the second chamber 115 is greater than the pressure of the first chamber 114, etc.

The foregoing description are merely specific implementations of the disclosure, but are not intended to limit the scope of protection of the disclosure. Any variation or replacement readily figured out by those skilled in the art within the technical scope disclosed in the disclosure shall fall within the scope of protection of the disclosure.

### LIST OF REFERENCE NUMERALS

10. electric drive device; 100. housing sealing structure; 110. housing body; 111. first housing portion; 112. second housing portion; 113. third housing portion; 114. first chamber; 115. second chamber; 116. partition plate; 121. first snap-fit portion; 122. snap-fit groove; 123. through hole; 124. first guide surface; 125. second guide surface; 130. busbar assembly; 131. second snap-fit portion; 132. boss; 133. busbar body; 134. support member; 140. sealing ring; 141. outer peripheral surface; 142. inner peripheral surface; 143. first protrusion; 144. second protrusion; 11. motor; 12. transmission; 13. motor controller.

1. A housing sealing structure for use in an electric drive device comprising a motor, a transmission, and a motor controller arranged in sequence, the housing sealing structure comprising:
a housing body comprising a partition plate, and a first chamber and a second chamber on two sides of the partition plate, the first chamber being configured to accommodate a transmission body to constitute the transmission, and the second chamber being configured to accommodate a motor controller body to constitute the motor controller;
a busbar assembly, the partition plate being provided with a through hole through which the busbar assembly passes such that the busbar assembly enters the first chamber from the second chamber; and
a sealing ring sleeved on the busbar assembly, an outer peripheral surface of the sealing ring fitting with a peripheral wall of the through hole in a sealing manner,
wherein the housing body is provided with a first snap-fit portion, and the busbar assembly is provided with a second snap-fit portion, the first snap-fit portion being snap-fitted with the second snap-fit portion to limit a position of the busbar assembly relative to the housing body.

2. The housing sealing structure according to claim 1, wherein
the partition plate is provided with a snap-fit groove serving as the first snap-fit portion, and the busbar assembly is provided with a boss serving as the second snap-fit portion.

3. The housing sealing structure according to claim 2, wherein
the snap-fit groove is an annular groove arranged surrounding the through hole, and a center line of the snap-fit groove is collinear with a center line of the through hole.

4. The housing sealing structure according to claim 2, wherein
the snap-fit groove is located on a side of the partition plate close to the second chamber.

5. The housing sealing structure according to claim 4, wherein
the through hole is formed in a bottom of the snap-fit groove, and a first guide surface is provided at an end of the through hole close to the snap-fit groove, and comprises a gradually shrinking opening in cross-section of the first guide surface in a direction from the snap-fit groove to the through hole to guide the sealing ring into the through hole.

6. The housing sealing structure according to claim 2, wherein
a second guide surface is provided at an opening of the snap-fit groove, and comprises a gradually shrinking opening in cross-section of the second guide surface in a direction of snap-in of the snap-fit groove with the boss to guide the boss to snap in the snap-fit groove.

7. The housing sealing structure according to claim 1, wherein the sealing ring is a rectangular sealing ring.

8. The housing sealing structure according to claim 7, wherein
a plurality of first protrusions are provided on an outer peripheral surface of the rectangular sealing ring.

9. The housing sealing structure according to claim 7, wherein
the rectangular sealing ring comprises an inner peripheral surface that fits with the busbar assembly in a sealing manner, and a plurality of second protrusions are provided on the inner peripheral surface.

10. The housing sealing structure according to claim 1, wherein
the housing body comprises a first housing portion, a second housing portion, and a third housing portion connected in sequence, and the partition plate is formed at the second housing portion,
wherein the first housing portion and the second housing portion are connected to each other to jointly define the first chamber, and
wherein the second housing portion and the third housing portion are connected to each other to jointly define the second chamber.

11. The housing sealing structure according to claim 1, wherein the busbar assembly comprises a busbar body and a support member that is made of plastic, the support member is connected to the busbar body, the sealing ring is sleeved on the support member, and the second snap-fit portion is arranged on the support member.

12. An electric drive device, comprising:
a motor body;
a transmission body;
a motor controller body; and
a housing sealing structure according to claim 1,
wherein the motor body is mounted in the first chamber, the transmission body is mounted in the first chamber, and the motor controller body is mounted in the second chamber, and
wherein one end of the busbar assembly is connected to the motor controller body, and the other end of the busbar assembly is connected to the motor body.
